(19) United States
(12) Patent Application Publication
(10) Pub. No.: US 2008/0088607 A1
(43) Pub. Date: Apr. 17, 2008

(54) Management of Internal Logic for Electronic Pens

(76) Inventors: Ola Sandstrom, Maimo (SE); Bjorn Fransson, Spanga (SE); Marianne Lindstrom, Stockholm (SE); Daniel Witalis, Vasterhaninge (SE); Lars Brorsson, Skurup (SE); Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 11/666,333

(22) PCT Filed: Nov. 7, 2005
(86) PCT No.: PCT/SE05/01664

§ 371 Date: Apr. 26, 2007

Related U.S. Application Data
(60) Provisional application No. 60/625,167, filed on Nov. 5, 2004.

(30) Foreign Application Priority Data
Nov. 5, 2004 (SE) 0402710-8

(51) Int. Cl. G06F 3/033

(52) U.S. Cl. 345/179

(57) ABSTRACT

In a system for managing information from electronic pens, each electronic pen includes a memory which is designed to store controlling software and a set of templates. Each template associates pen positions with functionality implemented by the controlling software. In a method and arrangement of controlling operation of electronic pens, a separate set of template versions are generated for each of a plurality of different versions of the controlling software. A pen, which stores a given version of the controlling software, is provided with a corresponding set, in which all template versions suitably indicates functionality which is fully implemented by the given version of the software.

### CROSS-REFERENCE TO RELATED APPLICATIONS

The present application claims the benefit of U.S. provisional patent application No. 60/625,167, filed on Nov. 5, 2004; and Swedish patent application No. 0402710-8, filed on Nov. 5, 2004, all of which are hereby incorporated by reference.

### FIELD OF THE INVENTION

The present invention generally relates to electronic pens capable of generating electronic information that reflects handwritten entries on a substrate.

### BACKGROUND ART

Electronic pens may incorporate a positioning system which traces the movement of the pen while it is used for writing on a passive substrate, such as a piece of paper, plastic, carton etc. The positioning system may infer the movement from, for example, a roller ball contacting the substrate, triangulation of signals from one or more external transmitters, acceleration sensors, strain sensors associated with a pen point contacting the substrate, images of a pattern on the substrate, or combinations thereof.

Such an electronic pen is capable of electronically recording a pen stroke as a sequence of positions.

The substrate may be provided with one or more input fields for entry or selection of dedicated information, or for initiation of a function. It may be desirable for the pen to give field-related user feedback (tactile, audible or visual), for example to indicate to the user that one or more positions has actually been recorded within an input field. Likewise, it may be desirable for the pen to be capable of operating independently from external devices.

To this end, the electronic pen may use one or more logic-defining templates, which during manufacture of the pen are stored in the pen's memory. Each such template is associated with one or more substrates or classes of substrates and indicates the location of at least part of the input fields on these substrates. The template also indicates a processing rule for each such input field. The processing rule may relate to any function of the pen, such as giving user feedback, processing certain pen strokes, causing the pen to provide data to an external device, etc. Such use of templates is further disclosed in Applicant's prior publication US 2003/0061188, which is herewith incorporated by reference.

The use of logic-defining templates has some inherent problems. The development of new substrates will be severely hampered if such new substrates should be supported by templates in existing pens. Thus, the first-developed templates will define the functionality that can be offered through after-developed substrates.

Further, a new generation of pens may be provided with software including new processing rules, i.e. enhanced functionality. Such a new generation of pens should store new templates with input fields associated with the new processing rules. For reasons of compatibility, it would be desirable for these “new” pens to be operational also on substrates developed for “old” pens, and conversely, for “old” pens to be operational also on substrates developed for “new” pens. This may be achieved, to some extent, by creating the new templates by adding new input fields to the first-developed templates.

To relax the dependence on the first-developed templates, it is conceivable to make the pens capable of adding new or updated templates to their memory after manufacture. Thereby, old pens may be brought to operate on new substrates or classes of substrates associated with a new or updated template. However, the software of old pens will not support all functionality indicated by such newly added templates. This results in potentially uncontrolled behavior of old pens, necessitating extensive testing whenever a new or updated template is to be released.

### SUMMARY OF THE INVENTION

The object of the invention is to overcome the above problems of the prior art.

Generally, the objects of the invention are at least partly achieved by means of methods, apparatus and arrangements according to the independent claims, embodiments being defined by the dependent claims.

According to one aspect, the invention relates to a method in a computer system communicating with an electronic pen, comprising: deriving from the pen a version identifier indicative of a set of processing rules stored by the pen; deriving, based on said version identifier, a logic version which associates pen positions with at least one rule identifier, whereby said at least one rule identifier is indicative of a processing rule in said set of processing rules; and providing said logic version to the pen.

According to a second aspect, the invention relates to an apparatus for communicating with an electronic pen, comprising: an interface for communicating with said pen; a first processing element which derives, from said pen and via said interface, a version identifier indicative of a set of processing rules stored by the pen; a second processing element which derives, based on said version identifier, a logic version which associates pen positions with at least one rule identifier, whereby said at least one rule identifier is indicative of a processing rule in said set of processing rules; and a third processing element which provides, via said interface, said logic version to the pen.

By selectively providing logic versions to the pen, based on the set of processing rules stored by the pen, the need for testing of pens may be reduced. In other words, the logic versions may be more or less tailored to the functionality offered by each pen.

The first and second aspects may be implemented by a computer program, which runs either on a local computer connected to the pen or on a network server to which the pen connects. In both cases, the logic versions are provided to the pen as propagating signals.

In one embodiment, every rule identifier in said logic version is indicative of a processing rule in said set of processing rules. Thus, the logic versions are fully tailored to the functionality of each pen, and there is no need for testing the operation of old pens whenever new or updated logic is introduced.

According to a third aspect, the invention relates to a method for creating a specific logic version for an electronic pen, which stores one of a plurality of different sets of processing rules, wherein a separate logic version is created for each set to comprise at least one rule identifier indicative of a processing rule in said set, said method comprising: deriving a full functionality logic which includes rule identifiers of all separate logic versions; deriving a version identifier indicative of a given set of processing rules; deriving, based on said version identifier, building instructions; and operating said building instructions on said full functionality logic to create said specific logic version, by eliminating at least one rule identifier that is unsupported by being indicative of a processing rule not included in the given set of processing rules.

According to a fourth aspect, the invention relates to an apparatus for creating a specific logic version for an electronic pen, which stores one of a plurality of different sets of processing rules, wherein a separate logic version is created for each set to comprise at least one rule identifier indicative of a processing rule in said set, said apparatus comprising: a first processing element which derives a full functionality logic which includes rule identifiers of all separate logic versions; a second processing element which derives a version identifier indicative of a given set of processing rules; a third processing element which, based on said version identifier, derives building instructions; and a fourth processing element which operates said building instructions on said full functionality logic to create said specific logic version, by eliminating at least one rule identifier that is unsupported by being indicative of a processing rule not included in the given set of processing rules.

The third and fourth aspects allow for efficient generation of separate logic versions for different pens, i.e. pens that store different sets of processing rules. These aspects may be implemented by the above-mentioned local computer or network server, for creation of one or more logic versions on demand. Alternatively, these aspects may be implemented by a freestanding computer, which eventually stores one or more of the resulting logic versions, suitably in association with the respective version identifier, either in a database accessible to the above-mentioned local computer or network server, or on a manually distributable computer-readable medium such as a CD ROM, floppy disk, USB memory, etc, which may be used by the above-mentioned local computer or network server to provide an adequate logic version to the pen.

According to a fifth aspect, the invention relates to a method of controlling operation of electronic pens in an information management system, wherein each electronic pen includes a memory which is designed to store controlling software and a set of logic versions, each such logic version indicating functionality implemented by said controlling software, said method comprising: generating a separate set of logic versions for each of a plurality of different versions of said controlling software; and providing a pen, which stores a given version of said controlling software, with a corresponding set, in which all logic versions indicates functionality which is fully implemented by said given version of said controlling software.

According to a sixth aspect, the invention relates to an arrangement for controlling operation of electronic pens in an information management system, wherein each electronic pen includes a memory which is designed to store controlling software and a set of logic versions, each such logic version indicating functionality implemented by said controlling software, said arrangement comprising: means for generating a separate set of logic versions for each of a plurality of different versions of said controlling software; and means for providing a pen, which stores a given version of said controlling software, with a corresponding set, in which all logic versions indicates functionality which is fully implemented by said given version of said controlling software.

Still other objectives, features, aspects and advantages of the present invention will appear from the following detailed disclosure, from the attached dependent claims as well as from the drawings.

### BRIEF DESCRIPTION OF THE DRAWINGS

The invention will now be described in more detail with reference to the accompanying schematic drawings, which for the purpose of exemplification show currently preferred embodiments.

FIG. 1 illustrates an information handling system including an electronic pen with internal logic.

FIG. 2 illustrates a logical partitioning of an abstract position-coding pattern into an addressable tree structure of page units.

FIG. 3 illustrates the relation of a logic-defining template to a position-coded substrate.

FIG. 4 is a cross-sectional view of an electronic pen that implements the principles of the present invention.

FIG. 5 illustrates layout and content of a position database stored in a memory block of the pen in FIG. 4.

FIG. 6 illustrates the principles of adapting the content of the position database to different pen generations.

FIG. 7 illustrates an arrangement for upgrading the position database of an electronic pen.

FIG. 8 illustrates an upgrade process executed by the arrangement in FIG. 7.

### DETAILED DESCRIPTION OF THE INVENTION

General

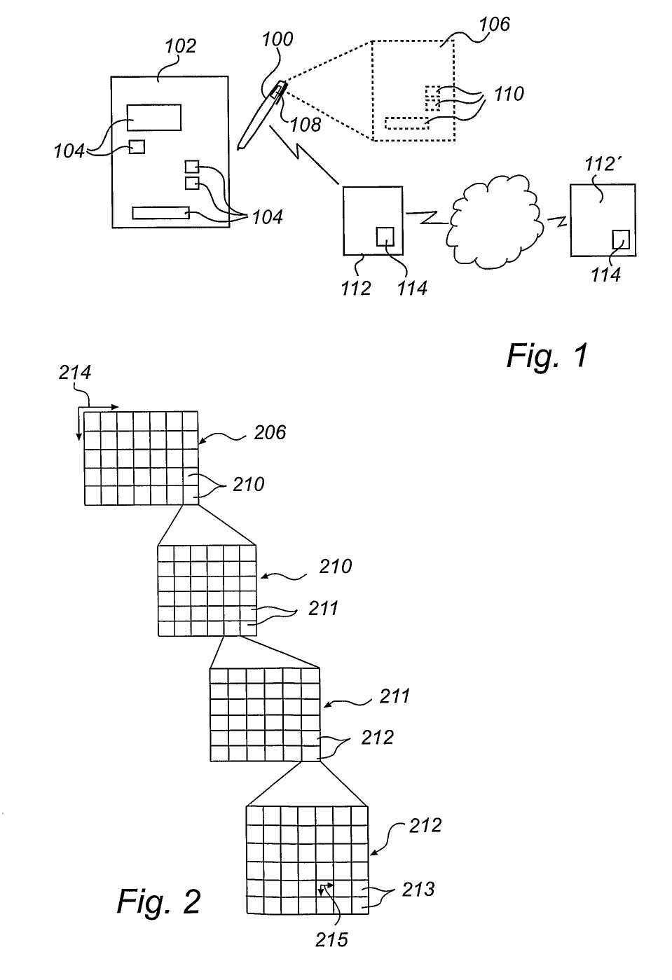

FIG. 1 illustrates some basic principles of electronic pens 100 with internal logic. The pen 100 is capable of recording its position on a substrate 102, while being used for writing thereon. Thus, the handwriting is digitized by the pen 100 into a sequence of absolute locations on the substrate 102. The pen 100 is also able to identify the substrate 102. The substrate 102 has supporting graphics which indicates input fields 104, and suitably prompts/instructs the user to enter the appropriate information. Each substrate 102 is associated with an electronic template 106 which is stored in pen memory 108. The template 106 associates positions on the substrate 102 with functional areas 110 and associates these functional areas 110 with functions to be executed by the pen control system. The functional areas 110 can, but need not, correspond to the graphically indicated input fields 104. The pen control system is implemented by software stored and executed in the pen.

The pen 100 continuously maps recorded positions against the relevant template. If a position is deemed to fall within a functional area 110, the pen control system executes the associated function.

The pen 100 also transmits or exposes all or part of the recorded data to one or more external devices 112, 112′. Ultimately, the thus-transmitted/exposed data is received and evaluated by a processing application 114, which is located either on a local device 112 (computer, telephone, Personal Digital Assistant, etc) or on a remote device 112′ (network server, computer, etc).

Abstract Pattern and Templates

The following description is based on the use of an abstract position-coding pattern, which is subdivided into page units. Examples of such abstract patterns are given in U.S. Pat. No. 6,663,008, U.S. Pat. No. 6,570,104 and U.S. Pat. No. 6,330,976, which are herewith incorporated by reference. The page units are addressable in a hierarchy of subordinate subsets, e.g. as disclosed in aforesaid US 2003/0061188.

FIG. 2 shows an example, in which the overall pattern 206 contains “segments” 210 which in turn are divided into a number of “shelves” 211, each containing a number of “books” 212 which are divided into a number of aforesaid page units 213, also called “pattern pages”. Suitably, all pattern pages have the same format within one level of the above pattern hierarchy. In the following exemplifying embodiment, the pattern page format is defined on segment level. In one example, each segment consists of more than 26,000,000 pattern pages, each with a size of about 50×50 cm². For example, such a segment may be divided into 5,175 shelves, each consisting of 2 books with 2,517 pages each.

The position of a certain pattern page in the abstract pattern can be noted as a page address of the form: segment.shelf.book.page, for instance 46.5000.1.1500, more or less like an IP address. For reasons of processing efficiency, the pen's internal representation of the page address may be different, for example given as an integer of a predetermined length, e.g. 64 bits.

Each pattern page may be regarded as an actual sub-set of the coding pattern, or as the absolute positions that are coded by the subset. Each such absolute position may be represented as a paper position, i.e. a global position in the coordinate system 214 of the overall pattern, or as a logical position, i.e. a page address and a local position in a coordinate system 215 within a pattern page.

The following description is based on each substrate containing a position code that corresponds to one or more pattern pages. It is to be noted, however, that the position code on a substrate need not conform to a pattern page. Thus, one or more subsets from one or more pattern pages may be arbitrarily arranged on the substrate.

A suitable electronic pen may represent its motion on a position-coded substrate as either a sequence of paper positions (i.e. a global pen stroke) or as a page address and a sequence of local positions on the corresponding pattern page (i.e. an addressed pen stroke).

The functionality of the pen is at least partly controlled by the user operating the pen on a specific part of the position-coding pattern. The pen stores different templates that define how the information that is recorded from different parts (functional areas) of the position-coding pattern is to be interpreted. A specific level in the pattern hierarchy is associated with a given template, which thus is valid for all pattern pages within that level. In the exemplifying embodiment, templates are defined on segment level.

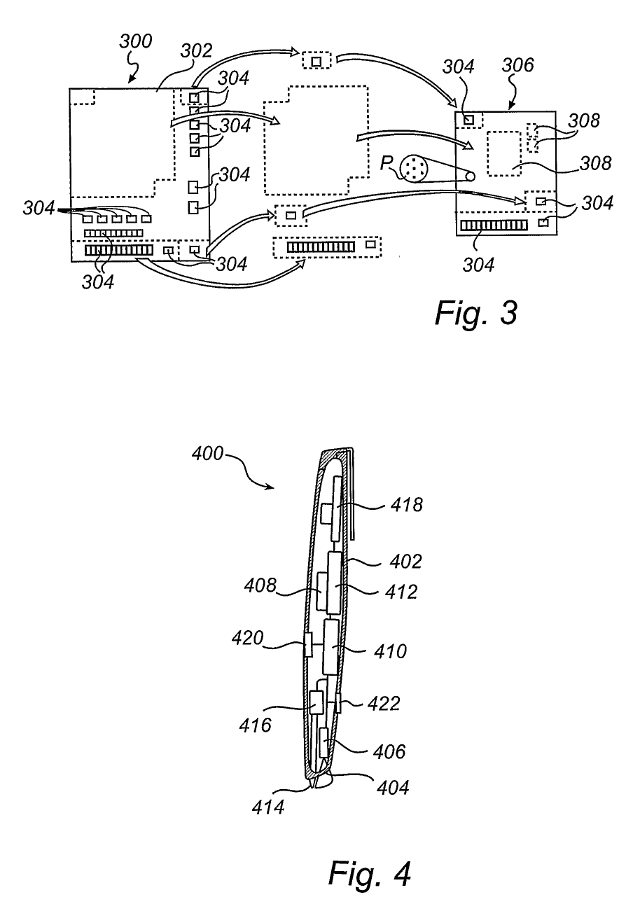

The template defines the size, placement and function of any functional areas that may affect the operation of the pen. Such functional areas are denoted as “pidgets”. FIG. 3 illustrates a template 300 graphically, as laid out on a pattern page 302, showing the placement of different pidgets 304.

In a template, all positions not occupied by any pidget within a pattern page are defined as belonging to a drawing area, which thus may be regarded as an implicit pidget. The positions detected in the drawing area are interpreted by the pen to be recorded and stored as pen strokes.

The pidgets may, i.a., indicate a trigger function, a service selection function, a device selection function, a local action function, a data selection function, or an interpretation function. The trigger function triggers the pen to expose or transmit data to an external device, such as a computer, a telephone, a network server, a PDA, etc. The service selection function identifies a service, which may convey context information (e.g. email, fax, SMS) that affects the pen's processing of recorded positions, and/or scope information (e.g. page, book, shelf) that affects the pen's selection of positions to be processed. The device selection function identifies a connection device for the pen (e.g. PC, mobile device, LAN access point). The local action function initiates an action that affects pen memory. The data selection function maps recorded positions to pen-resident data; e.g. a keyboard pidget may map positions to characters in the pen memory, or a shortcut pidget may map positions to communication addresses in the pen memory. The interpretation function may operate to convert one or more strokes within the pidget to machine-coded characters.

Another type of pidget indicates a new instance function, which operates to separate potentially overlapping pen strokes by associating each pen stroke with an instance identifier. For example, each initiation of a new instance function may result in a new instance identifier being generated for the relevant part of the abstract pattern, such as a pattern page or book, and any subsequently recorded pen strokes may then be associated with this instance identifier. The instance identifier is suitably associated with or incorporated in the page address.

In the exemplifying embodiment, the template defines each pidget 304 by a pidget ID, and a size and placement in local positions within a pattern page 302 (FIG. 3). The pidget ID is an identifier that determines the pidget function, by indicating a processing rule to be executed by the pen control system (see below).

FIG. 3 further illustrates the interrelation between pattern page 302, template 300 and tangible substrate 306. The substrate 306 includes a position code P that defines positions within one or more pattern pages 302 (only one shown in FIG. 3). Although the pidgets 304 have a predefined placement and size within the pattern page 302, they may have any placement on the substrate 306. Thus, parts of the pattern page may be “cut out” and re-assembled in any fashion on the substrate, as illustrated by the dotted sections in FIG. 3. Whenever the pen is put down on a coded part of the substrate, it records a position and is able to correlate this position to the relevant template and identify any function associated with the position. The substrate may also contain input fields 308 that are only known to the processing application (114 in FIG. 1), which associates processing instructions with these input fields.

Pen Hardware

FIG. 4 illustrates an embodiment of the above-mentioned pen 400, which has a pen-shaped casing or shell 402 that defines a window or opening 404, through which images are recorded. The casing contains a camera system, an electronics system and a power supply.

The camera system 406 comprises at least one illuminating light source, a lens arrangement and an optical image reader (not shown in the Figure). The light source, suitably a light-emitting diode (LED) or laser diode, illuminates a part of the area that can be viewed through the window 404, by means of infrared radiation. An image of the viewed area is projected on the image reader by means of the lens arrangement. The image reader may be a two-dimensional CCD or CMOS detector which is triggered to capture images at a fixed or variable rate, typically of about 70-100 Hz.

The power supply for the pen is advantageously a battery 408, which alternatively can be replaced by or supplemented by mains power (not shown).

The electronics system comprises a control unit 410 which is connected to a memory block 412. The control unit 410 is responsible for the different functions in the electronic pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 412 preferably comprises different types of memory, such as a working memory (e.g. a RAM) and a program code and persistent storage memory (a non-volatile memory, e.g. flash memory). Associated pen software is stored in the memory block 412 and is executed by the control unit 410 in order to provide a pen control system for the operation of the electronic pen.

The casing 402 also carries a pen point 414 which allows the user to write or draw physically on a surface by a pigment-based marking ink being deposited thereon. The marking ink in the pen point 414 is suitably transparent to the illuminating radiation in order to avoid interference with the opto-electronic detection in the electronic pen. A contact sensor 416 is operatively connected to the pen point 414 to detect when the pen is applied to (pen down) and/or lifted from (pen up), and optionally to allow for determination of the application force. Based on the output of the contact sensor 416, the camera system 406 is controlled to capture images between a pen down and a pen up. The control unit processes the images to calculate positions encoded by the imaged parts of the coding pattern. Such processing can, e.g. be implemented according to Applicant's prior publications: US 2003/0053699, US 2003/0189664, US 2003/0118233, US 2002/0044138, U.S. Pat. No. 6,667,695, U.S. Pat. No. 6,732,927, U.S. Pat. No. 6,929,183, US 2003/0128194, and references therein. The resulting sequence of temporally coherent positions forms an electronic representation of a pen stroke.

The electronics system further comprises a communications interface 418 for transmitting or exposing data to a nearby or remote apparatus such as a computer, mobile telephone, PDA, network server, etc. The communications interface 418 may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) 420 which is selectively activated for user feedback. The MMI may include a display, an indicator lamp, a vibrator, a speaker, etc.

Still further, the pen may include one or more buttons 422 by means of which it can be activated and/or controlled.

Property Storage

The pen software implements a Property Storage process which handles properties, including pen parameters and calibration parameters set in production, pen parameters set during operation of the pen, as well as templates (below). Each property is stored with name, size and data in the pen's non-volatile memory. The properties are also associated with at least one upgrade counter (see below) which indicates when the properties were last changed.

The Property Storage process provides an interface for insertion, retrieval and deletion of properties.

A non-exhaustive list of pen parameters include: PEN_ID (the pen's unique identity), PEN_SOFTWARE_VERSION (the version of the pen's software), PEN_MANUFACTURER_ID (the identity of the pen manufacturer), OPERATOR_ID (a unique identifier of an operator providing network access to the pen), PEN_OWNER_NAME, PEN_OWNER_ADDRESS, PEN_OWNER_EMAIL, PEN_OWNER_PHONE, and PEN_OWNER_FAX.

Position Database

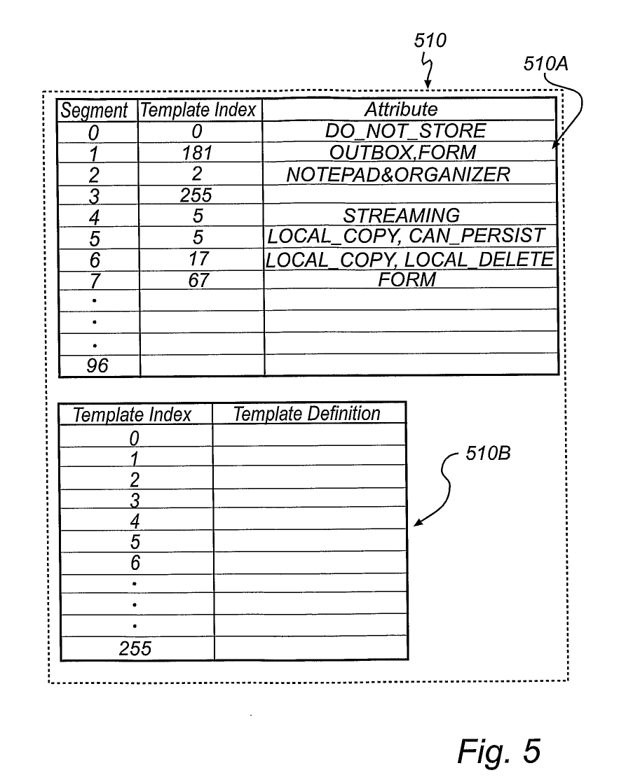

FIG. 5 shows an example of a position database 510 which resides in the memory block 412 (FIG. 4) of the pen and which can be edited or updated by the Property Storage process via the communications interface 418 (FIG. 4). The position database 510 is used by a Translator process (below) and contains a segment database 510A, which associates each segment with a template, given by a template index. The segment database 510A is suitably cached in RAM memory for fast access. The position database 510 also contains a template database 510B which associates the template index with a pointer to a template, which may be stored as a property in the pen's non-volatile memory.

Such a template may contain:
Page X Size (16 bits)
Page Y Size (16 bits)
Number of pages (16 bits)
Number of pidgets (16 bits)
Pidget List (Number of pidgets long)

The pidget list consists of a number of pidgets. Each pidget may be defined by:
Pidget ID (16 bits)
X upper left coordinate (16 bits)
Y upper left coordinate (16 bits)
Width (16 bits)
Height (16 bits)

The segment database 510A may also associate one or more functional attributes to each segment. The functional attribute may provide a classification to the segment, condition the processing of data belonging to the segment, or indicate an overall processing rule for the segment, as will be further described below.

Translator

The above-mentioned Translator process converts paper positions, which are derived from images of the position-coding pattern, to logical positions. The Translator process uses pattern formatting data that defines the hierarchical subdivision of the coding pattern into pattern pages (FIG. 2). Part of the pattern formatting data is predefined in the pen, while other parts are dynamically derived from the position database 510.

In the exemplifying embodiment, all segments have a predetermined size which is known to the Translator process. Thus, the Translator process may identify a current segment for any paper position that results from the decoding of an image. Based on the current segment, the Translator process may then derive data on the subdivision of the current segment from its template definition in the position database 510. In the exemplifying embodiment, the Translator process also knows that each row of pattern pages in each segment defines a shelf. Based on this pattern formatting data, the Translator process may further process the paper position to identify the current shelf, book, page, and local position, i.e. a full logical position. The Translator process may also derive any functional attributes associated with the current segment in the segment database 510A.

If the pen usually is operated on one and the same pattern page for some time, major speedup may be achieved by caching the boundaries of the current pattern page in paper positions, and by having the Translator process checking any new paper position against these boundaries. As long as the new paper positions fall within the boundaries, the need for a recalculation of the page address is eliminated.

The Translator process also detects if any recorded positions fall within a pidget on the current pattern page, by mapping the local positions against the relevant template, given by the position database 510. If no pidget is identified, the position is assumed to fall within a drawing area.

Thus, for each paper position, the Translator process provides at least a page address and a local position. For each temporally coherent sequence of positions, i.e. a stroke, the Translator process may also provide one or more pidget IDs, as well as any functional attribute(s) associated with the current segment.

Pen Control System

The pen control system operates on the output of the Translator process. The logical positions are grouped into temporally coherent sequences, i.e. strokes, which may be preprocessed for compression and encoding and then stored in non-volatile memory.

The pen control system also locates and executes any processing rule that the pen software associates with the respective pidget ID. Each such processing rule may include one or more processing instructions. The processing rule may cause the pen to operate the MMI (420 in FIG. 4), for example to give positive/affirmative feedback that a pidget ID has been recorded, and/or cause the pen to derive data from the memory block (e.g. based on detection of a keyboard pidget, a shortcut pidget or a trigger pidget) and/or cause the pen to execute a given operation on strokes recorded within a given part of a pattern page (e.g. based on detection of an interpretation pidget) and/or cause the pen to transmit or expose a given set of data via a given communications channel (e.g. based on detection of a trigger pidget), etc.

The pen control system may also associate a processing rule with a functional attribute that is identified by the Translator process. As mentioned above, the functional attributes provides a layer of logic on top of the templates and may operate to qualify, condition or indicate the processing to be effected by the pen. Below, a few examples are given for each of the different categories.

Functional Attributes

Qualifying Attributes

The pen control system may be caused to operate on all pen data that has a given functional attribute, e.g. by the pen control system detecting a dedicated pidget ID. Thus, the attribute qualifies the processing to be effected by the pen control system.

For example, at least part of the available segments may be classified as either FORM or NOTEPAD&ORGANIZER, as indicated by a respective functional attribute (see FIG. 5). For example, when the pen control system identifies a “Send all forms” trigger pidget, it will derive from the memory block all pen strokes falling within segments with a FORM attribute. As another example, a “Delete all notepads&organizers” trigger pidget will cause the pen control system to identify and delete all pen strokes falling within segments with a NOTEPAD&ORGANIZER attribute.

Conditioning Attributes

The conditioning attributes may control an external device's access to the pen data stored in the memory block. For example, a LOCAL_COPY attribute may indicate to the pen control system that all pen strokes falling within segments with this attribute will be or may be transferred when the pen is connected to a local PC. A LOCAL_DELETE attribute may indicate to the pen control system that the local PC can order the pen to delete from its memory block pen strokes falling within segments with this attribute. A CAN_PERSIST attribute may indicate to the pen control system that a network server is allowed to order the pen to maintain in its memory block pen strokes falling within segments with this attribute.

Indicating Attributes

The indicating attribute indicates a processing rule to be executed by the pen control system. Specifically, the indicating attribute may directly cause the pen to take specific action, or may cause the pen to modify a processing rule associated with a pidget ID. For example, a STREAMING attribute of a segment may cause the pen control system to stream pen strokes falling within this segment to an external device. A DO_NOT_STORE attribute of a segment may cause the pen to refrain from storing recorded pen strokes falling within this segment. An OUTBOX attribute may cause the pen to register an event in an outbox structure included in the memory block. Optionally, the event is only registered after detection of a trigger pidget. The outbox structure is essentially a list of events, in which each event identifies certain pen stroke data in the pen memory, e.g. pen strokes recorded on one or more given pattern pages. The outbox structure may be used to identify pen stroke data that should be processed collectively, e.g. upon connection of the pen to a given external device such as the local device 112 of FIG. 1. For example, upon such connection, the outbox list (and optionally the associated pen stroke data) may be transferred to this device for presentation and confirmation/denial, before being conveyed to the processing application.

Generally speaking, the functional attributes may be set on any level in the pattern page hierarchy and provides the advantage of separating comprehensive logic from the logic provided by the templates. Thus, the functional attributes provide a second level of logic, which can be set independently of the template logic and which is made available to the pen control system for a whole range of pattern pages.

Thus, in a general sense, the functional attributes enable advantageous operation of an electronic pen which is configured to record its position in a coordinate system and to process this position. The operation may comprise: storing data on individually addressable position groups in the coordinate system; and associating a set of such position groups with a global attribute; wherein any recorded position falling within the set of position groups is processed at least partly based upon the global attribute. Each such position group may be made up of a coherent set of positions in the coordinate system. The position groups may be of essentially identical format within the set of position groups. Thus, the position group may correspond to the aforesaid pattern page. In one embodiment, the global attribute may indicate a category for a recorded position falling within the set of position groups. In another embodiment, the global attribute may indicate a processing rule for a recorded position falling within the set of position groups. This processing rule may be selected from a group comprising: identifying the position group that contains the recorded position and adding the thus-identified position group to a list; providing the recorded position in real-time to an external device; prohibiting the pen from storing the recorded position in an internal memory; allowing the recorded position to be provided to an external device; allowing for an external device to delete the recorded position from an internal memory of the pen; and allowing for an external device to prohibit deletion of the recorded position from an internal memory of the pen.

Logic Management System

The templates as well as the functional attributes are stored as properties in the pen memory. By calling the interface of the Property Storage process in each pen, new or updated templates, attributes etc, may be added to the pen memory. This feature is used by a logic management system to control the logic definition of each pen, i.e. the content of its position database.

The pens are categorized into different “generations”, based upon the functionality provided by their pen control system. Similarly, different versions of the logic definition for a given segment are categorized into different “logic versions”. The logic management system is designed to ascertain that pens belonging to a given generation only store logic versions that are supported by their pen control system. Such supported logic versions contain pidget IDs and/or attributes that all are associated with valid processing rules in the pen control system. In the following, a collection of supported logic versions is referred to as a “family” of logic versions. A particular pen generation can only be associated with one family out of several different families.

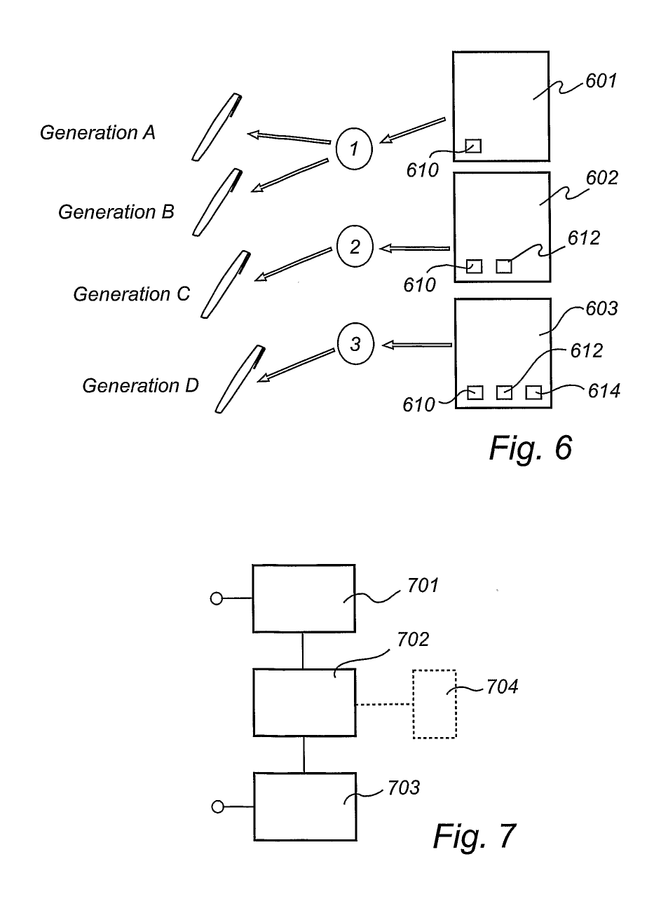

The underlying principle is further illustrated in FIG. 6. The position database for a segment is provided in three different logic versions 601-603, in this case three versions of a template, belonging to a respective Family 1-3. The pens are classified in four different generations. Pens in generations (software versions) A and B are associated with Family 1, and pens in generations (software versions) C and D are associated with Families 2 and 3, respectively. Logic versions 601-603 have pidget 610 in common, and logic versions 602-603 have pidget 612 in common. Pidget 614 is only included in logic version 603.

The content of a pen's position database may be managed by the pen connecting to a logic server on a network, which then upgrades the position database. Alternatively, the pen may connect to a local device (FIG. 1), which in turn retrieves relevant logic version(s) from the logic server and upgrades the position database. In yet another alternative, a logic upgrade kit may be provided to the pen user on a CD ROM, floppy disk, USB memory, etc, or via downloading from an Internet site. After proper installation in a local device communicating with the pen, the local device is capable of upgrading the position database.

FIG. 7 illustrates an arrangement for upgrading the position database of a pen. The arrangement is typically implemented by a combination of hardware and software on a computer, for example the above-mentioned local device or logic server. The arrangement has an input interface 701 for deriving pen generation information from the pen, an upgrade processor 702 for deriving relevant upgrade data, and an output interface 703 for communicating at least part of the thus-derived upgrade data to the pen.

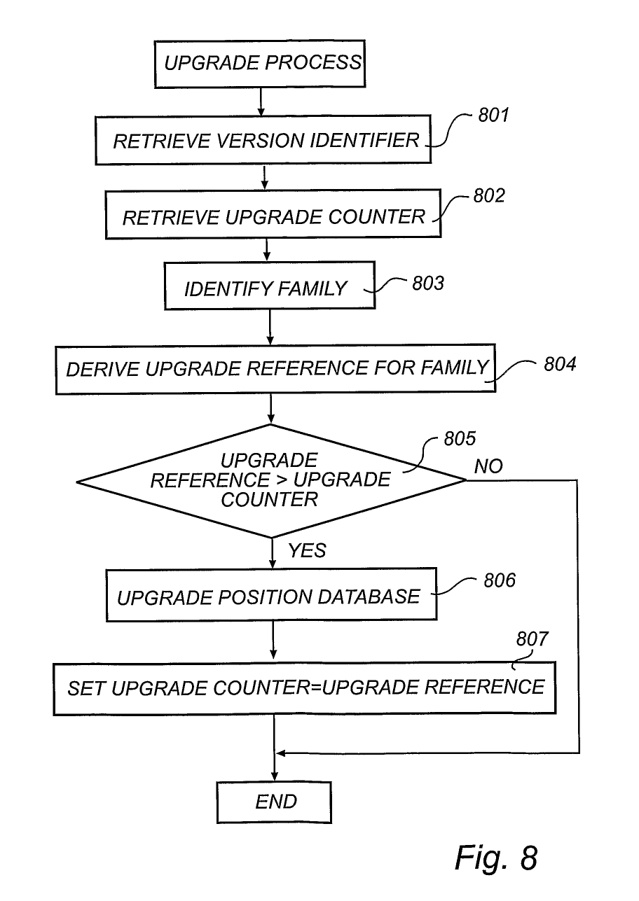

FIG. 8 illustrates an upgrade process in the arrangement of FIG. 7. First, the input interface 701 retrieves the property PEN_SOFTWARE_VERSION from the pen (step 801). This property identifies the pen generation, and thus the relevant upgrade data. The input interface 701 also retrieves the upgrade counter from the pen (step 802). This property indicates when the pen's position database was last upgraded. The upgrade processor 702 derives, e.g. from database 704, a reference counter for the relevant upgrade data (steps 803-804) and compares the pen's upgrade counter with the reference counter (step 805). If the reference counter exceeds the upgrade counter, the output interface 703 is brought to upgrade the pen's position database with the upgrade data, or part thereof (step 806), otherwise not. The upgrade data may include any of the following: new or updated template(s), new template index (es), new or updated functional attribute(s), new or updated segment(s). Finally, the pen's upgrade counter is updated to match the reference counter (step 807).

The reference counter may be a number in any suitable base, which is incremented whenever there is a change to the upgrade data of a family. Thus, the counter may be part of an arbitrary and incrementing number series or define the time of the latest upgrade.

The reference counter may be global and family-specific, i.e. applicable to a complete logic definition for a family. The database 704 may thus hold a complete logic definition for each family, each family being associated with a global reference counter. The upgrade processor 702 may then, based on the comparison in step 805, derive such a complete logic definition from the database 704 and provide it to the pen via the output interface 703.

Alternatively, each property (i.e. segment, template index, template, attribute) in the database 704 is tagged with a reference counter which indicates when the property was last changed. Thus, exactly those properties of a family that have actually been changed may be extracted from the database 704 and used to upgrade the pen's position database. In this embodiment, the database 704 may contain a range of reference counters, resulting from multiple changes to the upgrade data. Consequently, the pen's upgrade counter needs to be updated to match the highest reference counter identified by the upgrade process.

In addition to logic-related properties, the upgrade data may include a property which is unique to the specific pen and is unrelated to the logic definition of the pen, for example one of the above-mentioned pen parameters (PEN_OWNER_NAME, OPERATOR_ID, etc). In this case, the pen suitably stores a second upgrade counter (“item upgrade counter”) for such pen-unique properties. Likewise, the pen-unique part of the upgrade data is suitably associated with an item reference counter. Thus, in analogy to FIG. 8, the upgrade process may derive the pen identifier (PEN_ID) and the item upgrade counter from the pen; derive, based on the PEN_ID and from the database 704, at least one pen-unique property and the associated item reference counter; if the item reference counter exceeds the item upgrade counter, upgrade the pen's memory with the pen-unique property, and set the pen's item upgrade counter equal to the item reference counter. The item reference counter may be given for a set of pen-unique properties or for an individual pen-unique property. In the latter case, the pen's item upgrade counter is suitably set equal to the highest item reference counter identified by the upgrade process.

As indicated above, the database 704 may store pre-calculated upgrade data for each family. In one embodiment, a processor pre-calculates such upgrade data for a particular family by deriving an upgrade rule for this family. The processor also derives a set of full functionality templates. Each full functionality template defines all pidgets and functional attributes that are relevant to a specific segment, irrespective of pen generation. The upgrade rule defines a mechanism, e.g. including a filter, for building upgrade data for the particular family by extracting pidgets and functional attributes from the full functionality templates. Thus, by applying the upgrade rule on each full functionality template, the processor calculates the appropriate upgrade data. The resulting upgrade data is then provided for storage in the database 704, indexed by family.

Alternatively, the upgrade data is not pre-calculated but instead calculated on demand, suitably by the upgrade processor 702 executing the above procedure for calculating the upgrade data.

The above-mentioned upgrade rule may also involve deleting unsupported pidgets or functional attributes. This will make the position database of a pen fully compatible with the software stored by the pen. However, one or more of the deleted pidgets may be essential to the operability of the template. This may be the case when a segment originally is dedicated to a particular pen generation. For example, a deletion of a trigger pidget, service selection pidget or device selection pidget may make the pen unable to transmit/expose the recorded data. To make things worse, the pen may also be unable to indicate its inability to the user.

Therefore, the upgrade rule may also involve exchanging unsupported pidgets or functional attributes for supported ditto. Any number of unsupported pidgets may be exchanged for any number of supported pidgets. For example, an unsupported trigger pidget (“Send page to network via PC”) may be exchanged for a supported trigger pidget (“Send image of pen strokes on page to mobile phone”). This ensures forward compatibility, in that pens of later-developed pen generations are able to operate acceptably on segments dedicated to previous pen generations.

The full functionality template may be designed to include pure feedback pidgets, i.e. pidgets that only cause the pen to operate the MMI. Examples of such pidgets are an affirmative pidget which indicates pidget detection to the user, and a negative feedback pidget which indicates an operational failure to the user.

The feedback pidgets may replace other pidgets to ensure a uniform user experience. For example, it may be desirable for the pen to give affirmative feedback via the MMI whenever a pen stroke touches a pidget. Thus, instead of deleting an unsupported pidget from the full functionality template, if the functionality of this pidget is commensurate to the functionality offered by the template's supported pidgets, the unsupported pidget may be exchanged for an affirmative pidget. For example, if a “Send page” pidget is exchanged for a “Send image of pen strokes on page to mobile phone” pidget, a “Connect via mobile phone” pidget may, despite being redundant, be exchanged for an affirmative pidget, whereas a “Connect via PC” pidget should be exchanged for a negative feedback pidget.

To ensure full uniformity in the user experience, all unsupported pidgets in the full functionality template should be exchanged for either an affirmative or a negative feedback pidget.

It should be clear from the above that the upgrading process may also add, change or delete functional attributes, in dependence of the functionality supported by the pen control system.

Likewise, segments may be added, and template indexes may be added or changed.

In the case where a new segment is “opened” for a specific pen generation, by a template index and a template being added to the position database, this segment may in previous pen generations be assigned a “null template” which defines the pattern page as a pure drawing area. Any function to be initiated by the pen control system on this segment may be given by one or more functional attributes which are added to the position database of previous pen generations. Such a functional attribute is LOCAL_COPY, which will cause the pen to send/expose the recorded data on this segment upon connection to the local device. Thereby, data from this opened segment will be made available to the user, even if recorded by a pen of a previous generation.

There are many variations that may be made consistent with the present invention. The foregoing description is presented for purposes of illustration and explanation. It is not exhaustive and does not limit the invention to the precise form disclosed. Modifications and variations are possible in light of the above teachings or may be acquired from practicing the invention.

In one example, each pen could store a family identifier which directly identifies the relevant family to the management system. In another example, the management system infers the pen generation/family from the pen's unique identifier (PEN_ID).

The invention is not limited to the above type of code reading pens, but is applicable to any type of electronic pen that is capable of recording its position on a substrate, and executing a function based on the recorded position.

For example, the pen may operate on other types of patterns that code absolute positions, e.g. as disclosed in any one of U.S. Pat. Nos. 5,442,147; 5,652,412; 5,661,506; 5,852,434; 6,310,988; and 6,797,895. Further, instead of being based on an optical property, the coding pattern could include a chemical, acoustic, electro-magnetic, capacitive or inductive property. Evidently, the pen should have a sensor which is adapted to pick up such an alternative property. Still further, the pen may combine absolute and relative positioning techniques, by the pen recording at least one absolute reference position and relative positions in relation to this reference position. The absolute reference position(s) may be derived from a position-coding pattern on the substrate or by the pen user moving the pen to/from a predetermined location on the substrate. The relative positions may be derived from, e.g, a roller ball contacting the substrate, triangulation of signals from one or more external transmitters, acceleration sensors inside the pen, strain sensors operatively connected to the pen point contacting the substrate, images of surface irregularities or arbitrary patterns on the substrate, or any combination thereof.

Still further, instead of the substrate identity being given by the positions encoded on the substrate, an explicit substrate/page identifier may be embedded in the coding pattern. Alternatively, the substrate/page identifier may be given by a bar code on the substrate, or be printed in plain language on the substrate, to be recorded by a bar code reader or a text scanner in the pen.

The pen control may be supplemented by other events than detection of a pidget ID. Such other events include detection of a button on the pen being actuated by the user or detection of a verbal command as recorded by a microphone in the pen. For example, the use of trigger pidgets may be replaced or supplemented by such other events. Likewise, information about scope, context, device selection, etc may be indicated to the pen control system by such other events.

1. A method in a computer system communicating with an electronic pen, comprising:
deriving from the pen a version identifier indicative of a set of processing rules stored by the pen;
deriving, based on said version identifier, a logic version which associates pen positions with at least one rule identifier, whereby said at least one rule identifier is indicative of a processing rule in said set of processing rules; and
providing said logic version to the pen.

2. The method of claim 1, wherein every rule identifier in said logic version is indicative of a processing rule in said set of processing rules.

3. The method of claim 1, further comprising:
deriving an upgrade reference from a database associated with the computer system, wherein at least said step of providing said logic version is conditioned by detection of a given characteristic of said upgrade reference.

4. The method of claim 3, further comprising:
deriving an upgrade identifier from the pen, wherein said given characteristic is a relation between said upgrade identifier and said upgrade reference.

5. The method of claim 1, further comprising:
storing, in a database associated with the computer system, an upgrade reference that identifies said step of providing said logic version.

6. The method of claim 5, further comprising:
providing said upgrade reference to the pen for storage therein as an upgrade identifier.

7. The method of claim 1, wherein said set is one of a plurality of different sets of processing rules, a separate logic version being created for each set, wherein each such separate logic version is created by:
deriving a full functionality logic which includes rule identifiers of all logic versions;
deriving, based on said version identifier, building instructions; and
operating said building instructions on said full functionality logic to create said separate logic version, by eliminating any rule identifier that is unsupported by being indicative of a processing rule not included in the set indicated by the version identifier.

8. The method of claim 7, wherein at least one unsupported rule identifier is eliminated by omission.

9. The method of claim 7, wherein at least one unsupported rule identifier is eliminated by being replaced by a supported rule identifier which is indicative of a processing rule included in the set indicated by the version identifier.

10. The method of claim 9, wherein said supported rule identifier indicates a processing rule for controlling the pen to give negative feedback.

11. The method of claim 9, wherein said supported rule identifier indicates a processing rule for controlling the pen to give affirmative feedback.

12. The method of claim 7, further comprising:
storing each separate logic version in a database in association with said version identifier.

13. An apparatus for communicating with an electronic pen, comprising:
an interface for communicating with said pen;
a first processing element which derives, from said pen and via said interface, a version identifier indicative of a set of processing rules stored by the pen;
a second processing element which derives, based on said version identifier, a logic version which associates pen positions with at least one rule identifier, whereby said at least one rule identifier is indicative of a processing rule in said set of processing rules; and
a third processing element which provides, via said interface, said logic version to the pen.

14. The apparatus of claim 13, wherein every rule identifier in said logic version is indicative of a processing rule in said set of processing rules.

15. The apparatus of claim 13, wherein said first processing element is designed to derive an upgrade reference from a database associated with the computer system, wherein operation of at least said third processing element to provide said logic version is conditioned by said first processing element detecting a given characteristic of said upgrade reference.

16. The apparatus of claim 15, wherein said first processing element is designed to derive, via said interface, an upgrade identifier from the pen, wherein said given characteristic is a relation between said upgrade identifier and said upgrade reference.

17. The apparatus of claim 13, wherein said third processing element is designed to store, in a database associated with the computer system, an upgrade reference that identifies an operation of providing said logic version.

18. The apparatus of claim 17, said third processing element is designed to provide, via said interface, said upgrade reference to the pen for storage therein as an upgrade identifier.

19. A method for creating a specific logic version for an electronic pen, which stores one of a plurality of different sets of processing rules, wherein a separate logic version is created for each set to comprise at least one rule identifier indicative of a processing rule in said set, said method comprising:
deriving a full functionality logic which includes rule identifiers of all separate logic versions;
deriving a version identifier indicative of a given set of processing rules;
deriving, based on said version identifier, building instructions; and
operating said building instructions on said full functionality logic to create said specific logic version, by eliminating at least one rule identifier that is unsupported by being indicative of a processing rule not included in the given set of processing rules.

20. The method of claim 19, wherein said version identifier is derived from said electronic pen.

21. The method of claim 19, wherein said specific logic version is stored in a database in association with said version identifier.

22. The method of claim 19, wherein said specific logic version is provided to the pen as a propagating signal over an electronic network.

23. The method of claim 19, wherein said specific logic version is stored on a manually distributable computer-readable storage medium.

24. An apparatus for creating a specific logic version for an electronic pen, which stores one of a plurality of different sets of processing rules, wherein a separate logic version is created for each set to comprise at least one rule identifier indicative of a processing rule in said set, said apparatus comprising:
a first processing element which derives a full functionality logic which includes rule identifiers of all separate logic versions;
a second processing element which derives a version identifier indicative of a given set of processing rules;
a third processing element which, based on said version identifier, derives building instructions; and
a fourth processing element which operates said building instructions on said full functionality logic to create said specific logic version, by eliminating at least one rule identifier that is unsupported by being indicative of a processing rule not included in the given set of processing rules.

25. The apparatus of claim 24, wherein said second processing element derives said version identifier from said electronic pen.

26. The apparatus of claim 24, further comprising a fifth processing element which stores said specific logic version in a database in association with said version identifier.

27. The apparatus of claim 24, further comprising a sixth processing element which provides said specific logic version to the pen as a propagating signal over an electronic network.

28. The apparatus of claim 24, further comprising a sixth processing element which stores said specific logic version on a manually distributable computer-readable storage medium.

29. A method of controlling operation of electronic pens in an information management system, wherein each electronic pen includes a memory which is designed to store controlling software and a set of logic versions, each such logic version indicating functionality implemented by said controlling software, said method comprising:
generating a separate set of logic versions for each of a plurality of different versions of said controlling software; and
providing a pen, which stores a given version of said controlling software, with a corresponding set, in which all logic versions indicates functionality which is fully implemented by said given version of said controlling software.

30. The method of claim 29, wherein said all logic versions include at least one rule identifier indicative of a processing rule, every such processing rule being implemented by said given version of said controlling software.

31. The method of claim 30, wherein each logic version associates pen positions with said at least one rule identifier.

32. The method of claim 31, wherein said electronic pen includes a sensor device which generates digital representations of a position-coding pattern, and a signal processing device which derives said pen positions from said digital representations.

33. The method of claim 31, wherein said pen positions are absolute positions in an overall coordinate system.

34. The method of claim 33, wherein said memory is designed to store each logic version in association with a subset of said coordinate system.

35. The method of claim 34, wherein said logic version defines a set of page units within said subset and the location of at least one functional area within each of said page units, each such functional area being associated with one of said rule identifiers.

36. The method of claim 33, wherein said logic version defines a set of page units within said subset and associates one of said rule identifiers with said subset.

37. A system for controlling operation of electronic pens in an information management system, wherein each electronic pen includes a memory which is designed to store controlling software and a set of logic versions, each such logic version indicating functionality implemented by said controlling software, said system comprising:
means for generating a separate set of logic versions for each of a plurality of different versions of said controlling software; and
means for providing a pen, which stores a given version of said controlling software, with a corresponding set, in which all logic versions indicates functionality which is fully implemented by said given version of said controlling software.

38. (canceled)

39. (canceled)

40. (canceled)

41. (canceled)

42. (canceled)

43. (canceled)

44. (canceled)
